(19) United States
(12) Patent Application Publication
(10) Pub. No.: US 2026/0011347 A1
(43) Pub. Date: Jan. 8, 2026

(54) NETWORK SYSTEM, SERVER APPARATUS, AND CONTROL METHOD THEREOF

(71) Applicant: CANON KABUSHIKI KAISHA, Tokyo (JP)

(72) Inventor: NAOYA KOSUGI, Tokyo (JP)

(21) Appl. No.: 19/248,273

(22) Filed: Jun. 24, 2025

(30) Foreign Application Priority Data
Jul. 4, 2024 (JP) 2024-108102

(51) Int. Cl. G11B 27/06

(52) U.S. Cl. CPC G11B 27/06

(57) ABSTRACT

A network system providing a service of uploading moving image data includes one or more memories, and one or more processors in communication with the one or more memories, wherein the one or more processors and the one or more memories are configured to acquire predetermined information when accepting upload of moving image data from a moving image data transfer apparatus, and generate moving image data for display of the moving image data at a time of uploading the moving image data from the moving image data transfer apparatus in accordance with the predetermined information.

### BACKGROUND

### Field of the Technology

The present disclosure relates to a network system that provides a service for uploading moving image data, a server apparatus, a control method thereof, and a program.

### Description of the Related Art

In relation to network systems that provide services for uploading moving image data, there are known techniques for dividing moving image data to be uploaded and adding various kinds of information to the divided moving image data (refer to Japanese Patent Application Laid-Open No. 2010-119092 and Japanese Patent Application Laid-Open No. 2022-96304).

Japanese Patent Application Laid-Open No. 2010-119092 discusses a configuration in which an original moving image to be uploaded is divided into a plurality of moving images for uploading, and the moving images are uploaded to a web server in descending order of replay time, and notification information is added to the moving images for uploading.

Japanese Patent Application Laid-Open No. 2022-96304 discusses a configuration in which a moving image file transfer apparatus generates a plurality of divided transfer files, each of which contains divided moving image data obtained by dividing moving image data contained in a moving image file to be transferred and management information for the divided moving image data, and transfers the plurality of divided transfer files and the management information contained in the moving image file to an external device.

In a network system that provides a service for uploading moving image data, it may be useful and effective to generate moving image data for display of the moving image data at a time of uploading moving image data. However, the cost can be high in a case where moving image data for display is generated uniformly for all moving image data to be uploaded at the time of uploading. The techniques discussed in Japanese Patent Application Laid-Open No. 2010-119092 and Japanese Patent Application Laid-Open No. 2022-96304 do not appear to address the high cost associated with the case where moving image data for display is generated uniformly for all moving image data to be uploaded at the time of uploading.

### SUMMARY

The present disclosure has been made in view of the above-described issue, and aims to generate moving image data for display of the moving image data at a time of uploading moving image data in effective situations, thereby achieving cost reduction.

A network system providing a service of uploading moving image data includes one or more memories, and one or more processors in communication with the one or more memories, wherein the one or more processors and the one or more memories are configured to acquire predetermined information when accepting upload of moving image data from a moving image data transfer apparatus, and generate moving image data for display of the moving image data at a time of uploading the moving image data from the moving image data transfer apparatus in accordance with the predetermined information.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of an overall configuration of a network system according to an exemplary embodiment.

FIG. 2 is a block diagram illustrating a configuration example of an information processing server and an information processing apparatus according to the exemplary embodiment.

FIG. 3 is a block diagram illustrating a configuration example of an imaging apparatus according to the exemplary embodiment.

FIG. 4 is a flowchart illustrating an example of processing executed by the information processing server according to the exemplary embodiment.

FIG. 5 is a flowchart illustrating an example of processing executed by the information processing server according to the exemplary embodiment.

FIG. 6 is a flowchart illustrating an example of processing executed by the information processing server according to the exemplary embodiment.

FIGS. 7A and 7B are flowcharts illustrating examples of processing executed by the imaging apparatus and the information processing apparatus according to the exemplary embodiment.

### DESCRIPTION OF THE EMBODIMENTS

Hereinafter, preferred exemplary embodiments of the present disclosure will be described with reference to the accompanying drawings.

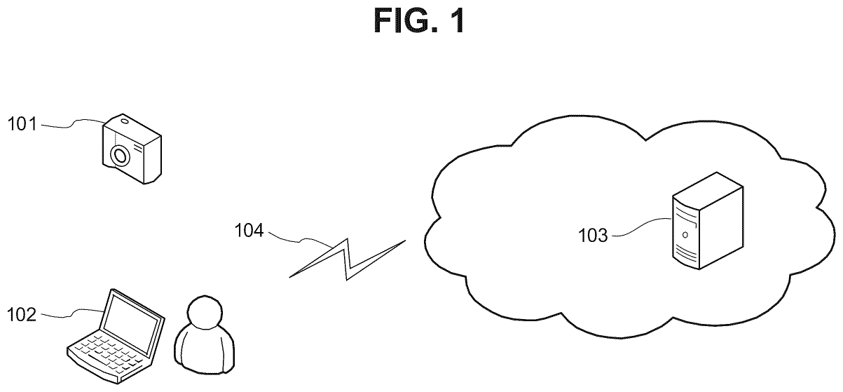

FIG. 1 is a diagram illustrating an example of an overall configuration of a network system according to an exemplary embodiment. The network system includes an imaging apparatus 101, an information processing apparatus 102, and an information processing server 103. The information processing server 103 is communicable with the imaging apparatus 101 and the information processing apparatus 102 via a network 104. The network 104 can be a wireless or wired communication network. The network system provides a service for uploading moving image data. In the present exemplary embodiment, in a cloud data storage service, moving image data captured by the imaging apparatus 101 is uploaded to the information processing server 103, and data processing is performed by the information processing server 103.

The imaging apparatus 101 captures a moving image and uploads the moving image data to the information processing server 103. In the present exemplary embodiment, the imaging apparatus 101 functions as a moving image data transfer apparatus in the present disclosure. The format, codec, and the like of the moving image data are not limited to specific ones.

The information processing apparatus 102 displays moving image data for display generated by the information processing server 103.

The information processing server 103 provides a service for uploading moving image data, generates moving image data for display of the moving image data uploaded from the imaging apparatus 101, and transmits the moving image data for display to the information processing apparatus 102.

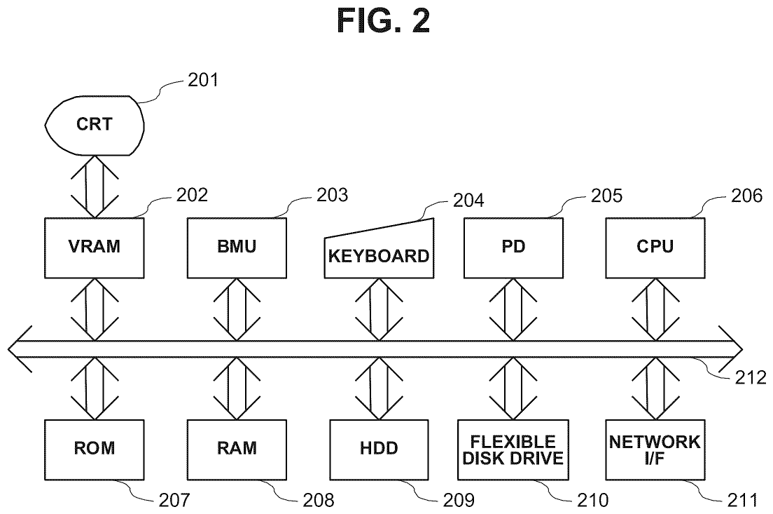

FIG. 2 is a block diagram illustrating a configuration example of the information processing server 103.

As illustrated in FIG. 2, the information processing server 103 includes a cathode ray tube (CRT) display 201, a moving image random access memory (VRAM) 202, a bit move unit (BMU) 203, a keyboard 204, and a pointing device (PD) 205. The information processing server 103 also includes a central processing unit (CPU) 206, a read only memory (ROM) 207, a RAM 208, a hard disk drive (HDD) 209, a flexible disk drive 210, a network interface (I/F) 211, and a bus 212.

The CRT display 201 displays icons, messages, menus, and other user interface information managed by the information processing server 103, for example.

In the VRAM 202, images to be displayed on the CRT display 201 are drawn.

The image data generated in the VRAM 202 is transferred to the CRT display 201 in accordance with a predetermined standard, whereby an image is displayed on the CRT display 201.

The BMU 203 controls data transfer between memories (e.g., between the VRAM 202 and other memories) and data transfer between a memory and each input/output (I/O) device (e.g., the network I/F 211).

The keyboard 204 has various keys for inputting characters and the like.

The PD 205 is used to point to an icon, a menu or other contents displayed on the CRT display 201 or to drag and drop an object, for example.

The CPU 206 controls each device based on an operating system (OS) and various control programs stored in the ROM 207, the HDD 209, or a flexible disk read and written by the flexible disk drive 210. The control programs can also be provided to the CPU 206 from the ROM 207, the HDD 209, or the flexible disk or from another server or the like over a network via the network I/F 211. The CPU 206 executes predetermined control programs to function as an acquisition unit, a generation unit, and a transmission unit described in the present disclosure.

The ROM 207 stores various control programs and data.

The RAM 208 has a work area for the CPU 206, an area for saving data during error processing, an area for loading control programs, and the like.

The HDD 209 stores various control programs, temporarily kept data, and the like.

The flexible disk drive 210 reads and writes data from and to a flexible disk.

The network I/F 211 communicates with external devices, such as the imaging apparatus 101 and the information processing apparatus 102, via a network.

The bus 212 includes an address bus, a data bus, and a control bus.

Although FIG. 2 illustrates a configuration example of the information processing server 103, the information processing apparatus 102 also has a similar configuration.

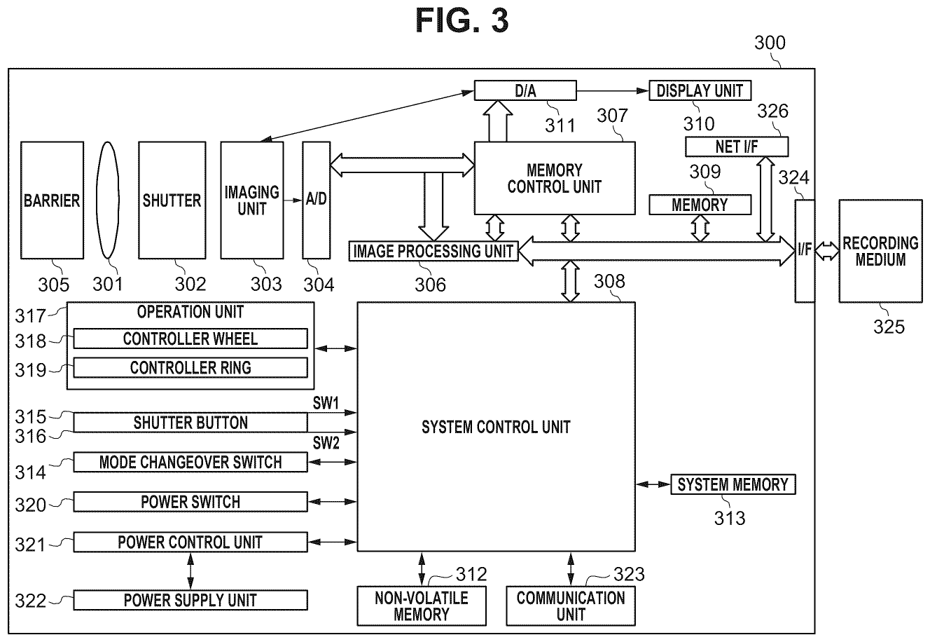

FIG. 3 is a block diagram illustrating a configuration example of the imaging apparatus 101.

The imaging apparatus 101 includes an imaging lens 301, a shutter 302, an imaging unit 303, an analog/digital (A/D) converter 304, and a barrier 305. The imaging apparatus 101 also includes an image processing unit 306, a memory control unit 307, a system control unit 308, a memory 309, a display unit 310, a digital/analog (D/A) converter 311, a non-volatile memory 312, and a system memory 313.

The imaging apparatus 101 also includes a mode changeover switch 314, a first shutter switch 315, a second shutter switch 316, and an operation unit 317. The imaging apparatus 101 also includes a power switch 320, a power supply control unit 321, a power supply unit 322, a communication unit 323, an interface (I/F) 324, and a network I/F 326.

The imaging lens 301 includes a zoom lens and a focus lens.

The shutter 302 has an aperture function.

The imaging unit 303 consists of a charge-coupled device (CCD) element or a complementary metal oxide semiconductor (CMOS) element for converting an optical image into an electrical signal.

The A/D converter 304 converts an analog signal output from the imaging unit 303 into a digital signal.

The barrier 305 covers the imaging lens 301 and the like to prevent the imaging system including the imaging lens 301, the shutter 302, and the imaging unit 303, from becoming dirty or damaged.

The image processing unit 306 performs predetermined pixel interpolation, resizing, such as reduction, and color conversion processing, on the image data from the A/D converter 304 or the image data from the memory control unit 307. The image processing unit 306 also performs predetermined calculation processing using the captured image data, and then the system control unit 308 performs exposure control and distance measurement control based on the calculation results. The image data output from the A/D converter 304 is written in the memory 309 via the image processing unit 306 and the memory control unit 307, or via only the memory control unit 307.

The system control unit 308 controls the entire imaging apparatus 101. The system control unit 308 implements the processing of the imaging apparatus 101 by executing a program stored in the non-volatile memory 312.

The memory 309 stores image data obtained by the imaging unit 303 and converted into digital data by the A/D converter 304, and image data to be displayed on the display unit 310. The memory 309 has a storage capacity sufficient to store a predetermined number of still images and a predetermined time period of moving images and audio. The memory 309 also serves as a memory for displaying images (video memory).

The D/A converter 311 converts the image data for display stored in the memory 309 into an analog signal, and supplies the analog signal to the display unit 310. The image data for display written in the memory 309 is displayed by the display unit 310 via the D/A converter 311.

The display unit 310 displays on a display device, such as a liquid crystal display (LCD), in accordance with the analog signal from the D/A converter 311.

The non-volatile memory 312 is an electrically erasable and recordable memory, such as an electrically erasable programmable ROM (EEPROM). The non-volatile memory 312 stores constants for the operation of the system control unit 308, various control programs, and the like.

The system memory 313 is a RAM, for example, and develops constants and variables for the operation of the system control unit 308, programs read from the non-volatile memory 312, and the like.

The mode changeover switch 314, the first shutter switch 315, the second shutter switch 316, and the operation unit 317 are operation means for inputting various operation instructions to the system control unit 308. The mode changeover switch 314 switches the operation mode of the system control unit 308 to any one of a still image recording mode, a moving image recording mode, a replay mode, and the like. The first shutter switch 315 is turned on in the course of operation of the shutter button provided on the imaging apparatus 101, that is, by half-pressing the shutter button (imaging preparation instruction), and generates a first shutter switch signal SW1. The second shutter switch 316 is turned on at the completion of operation of the shutter button, that is, by fully pressing the shutter button (imaging instruction), and generates a second shutter switch signal SW2. In response to the second shutter switch signal SW2, the system control unit 308 starts a series of operations for imaging processing from reading a signal from the imaging unit 303 to writing image data to a recording medium 325.

Operation members of the operation unit 317 act as various function buttons with appropriate functions assigned for each scene by selecting and operating various function icons displayed on the display unit 310. Examples of the function buttons include, for example, a confirmation button, an end button, a back button, an image forward button, a jump button, a filter button, an attribute change button. For example, when the menu button is pressed, a menu screen in which various settings can be made is displayed on the display unit 310. The user can intuitively make various settings using the menu screen displayed on the display unit 310, a four-way button, and a set button.

The operation unit 317 includes a controller wheel 318 and a controller ring 319. The controller wheel 318 is a rotatable operation member, and is used together with a direction button to specify a selection item. The system control unit 308 controls each component of the imaging apparatus 101 based on a pulse signal. The system control unit 308 can determine the angle at which the controller wheel 318 has been rotated and the cycles of rotation, from the pulse signal. The controller wheel 318 can be any operation member that is capable of detecting a rotation operation. The controller ring 319 is a rotation operation member, and can be operated to rotate around the lens barrel centered on the optical axis. For example, the controller ring 319 is operated to generate an electrical pulse signal corresponding to the amount of rotation (amount of operation). The system control unit 308 controls each component of the imaging apparatus 101 based on the pulse signal. When a function switching button on the controller ring 319 is pressed, a menu screen is displayed on the display unit 310 in which the function assigned to the controller ring 319 can be changed. The controller ring 319 and the controller wheel 318 are typically used to select mode items and change values.

The power switch 320 is used to switch between power on and off.

The power supply control unit 321 includes a battery detection circuit, a direct current (DC)-DC converter, a switch circuit for switching between blocks to which electricity is applied, and the like. The power supply control unit 321 detects the presence or absence of a battery, the type of the battery, and the remaining battery power. The power supply control unit 321 also controls the DC-DC converter based on the detection results and instructions from the system control unit 308, and supplies the required voltage for the required period to each component, including the recording medium 325.

The power supply unit 322 consists of a primary battery such as an alkaline battery or a lithium battery, a secondary battery such as a nickel-cadmium (NiCd) battery, a nickel-metal hydride (NiMH) battery, or a lithium (Li) battery, an alternating-current (AC) adapter, or the like.

The communication unit 323 transmits the image data stored in the recording medium 325 to an external device.

The I/F 324 is an interface with the recording medium 325. The recording medium 325 consists of a semiconductor memory, a magnetic disk, or the like.

The network I/F 326 is controlled by the system control unit 308 and performs communication via the network 104.

FIG. 3 illustrates a configuration example of the imaging apparatus 101, and the configuration of the imaging apparatus 101 is not limited to this. For example, the shutter 302, the mode changeover switch 314, the display unit 310, and the like are not essential components of an imaging apparatus to which the present disclosure is applied.

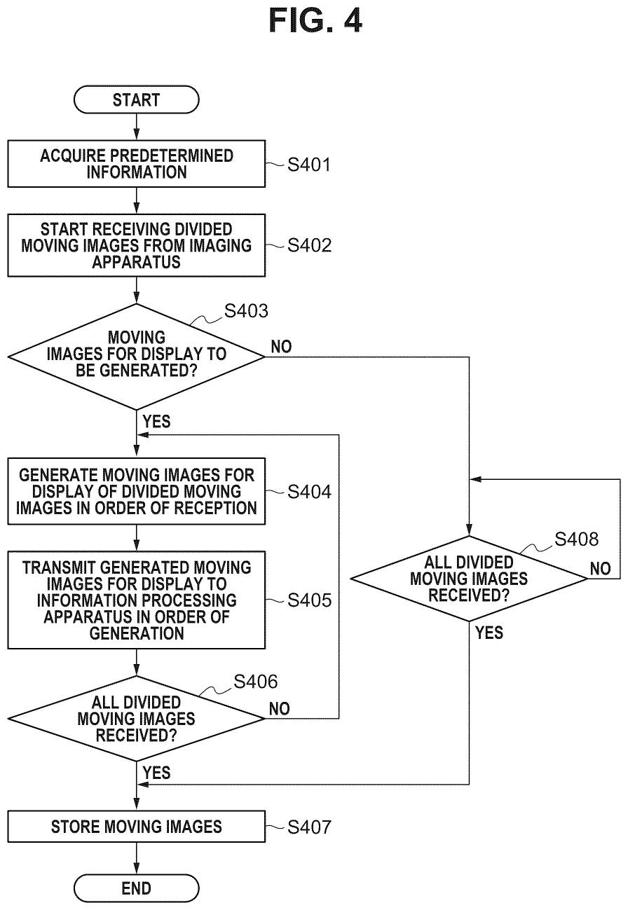

FIG. 4 is a flowchart illustrating an example of processing executed by the information processing server 103. The process in the flowchart is implemented by the CPU 206 executing a predetermined control program.

Hereinafter, an example will be described in which moving image data is divided and uploaded from the imaging apparatus 101 to the information processing server 103, and at the time of uploading of the moving image data, moving image data for display of the moving image data is generated and displayed on the information processing apparatus 102 to enable a streaming method. The process in the flowchart is started in response to a request for uploading a moving image from the imaging apparatus 101 (step S702 described below).

In step S401, the information processing server 103 acquires predetermined information transmitted from the imaging apparatus 101. The predetermined information is information used to determine whether it is necessary to generate moving image data for display in step S403 described below. The predetermined information can be user information, such as the user's replay history and login history in this service, for example. The predetermined information can also be information on the moving image to be uploaded. Although user information or moving image information is set here as the predetermined information, other information can also be used in addition to or instead of this.

In step S402, the information processing server 103 starts receiving divided moving image data obtained by dividing the moving image data from the imaging apparatus 101.

In step S403, the information processing server 103 determines whether it is necessary to generate moving image data for display based on the predetermined information acquired in step S401. If moving image data for display is to be generated (YES in step S403), the processing proceeds to step S404. If no moving image data for display is to be generated (NO in step S403), the processing proceeds to step S408. Upon completion of the reception of the divided moving image data that began to be received in step S402, the processing proceeds to step S407. For example, in a case where the predetermined information is user information, it is determined that moving image data for display is to be generated when a value indicating the user's frequency of replaying moving images or performing a login exceeds a predetermined threshold. It is determined that moving image data for display is to be generated for all new users with no history record. In a case where the predetermined information is moving image information, it is determined that moving image data for display is to be generated when the moving image to be uploaded corresponds to a tendency of moving images that are frequently replayed, based on statistical information collected in advance in the cloud service.

In step S404, the information processing server 103 generates moving image data for display of the divided moving image data that began to be received in step S402 in the order in which they have been received.

In step S405, the information processing server 103 transmits the moving image data for display generated in step S404 to the information processing apparatus 102 for display in the order in which they have been generated.

In step S406, the information processing server 103 determines whether the reception of the divided moving image data that started to be received in step S402 has been completed. In a case where the reception of the divided moving image data has not been completed (NO in step S406), the processing returns to step $404. In a case where the reception of the divided moving image data has been completed (YES in step $406), the processing proceeds to step S407.

In step S407, when the information processing server 103 has generated the moving image data for display in step S404, the information processing server 103 stores the moving image data for display in a storage area on the information processing server 103. Regardless of generation or non-generation of moving image data for display, the information processing server 103 saves the moving image data uploaded from the imaging apparatus 101 in a storage area on the information processing server 103. Although the moving image data for display here is saved in the information processing server 103, the moving image data for display can also be saved in a different server apparatus or terminal, as long as communication with the information processing server 103 and the information processing apparatus 102 is established and the moving image data for display can be moved to such a location.

In a case where the imaging apparatus 101 is capable of transmitting proxy moving image data, information can also be acquired as to whether the imaging apparatus 101 is a model compatible with proxy moving images or whether the proxy moving image data and the original moving image data that is the source of the proxy moving image data will be transmitted simultaneously. In a case where such information has been transmitted, the process waits until the proxy moving image data is transmitted from the imaging apparatus 101. In step S404, moving image data for display is generated from the proxy moving image data, and the moving image data for display is associated with the original moving image data.

In addition to the moving image data for display of the divided moving image data, still image data for display can also be generated. For example, in steps S403, S404, and S405, the necessity for generating still image data for display can be determined, and the generated still image data for display can be transmitted, respectively.

In this example, the process in the flow has been described in which moving image data is divided and uploaded, and then the necessity for generating moving image data for display is determined and the moving image data for display is generated in parallel, thereby more efficiently presenting the moving image data for display to the user. However, dividing the moving image data is not a required operation.

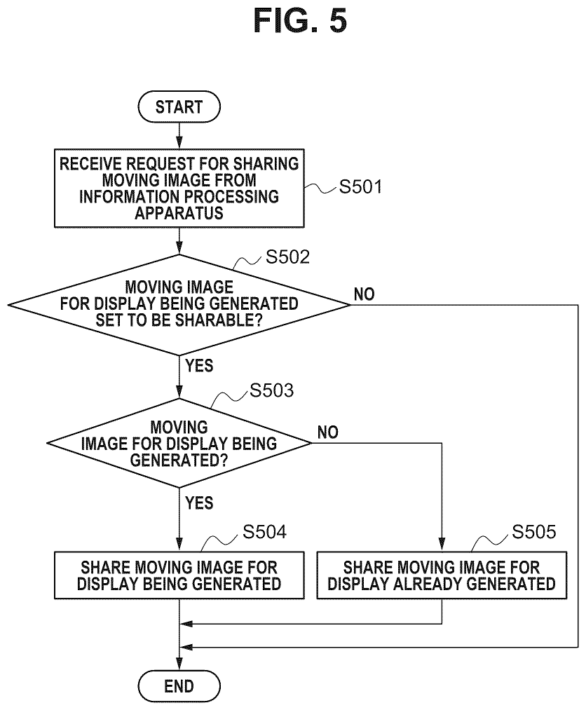

FIG. 5 is a flowchart illustrating an example of processing executed by the information processing server 103. The process in the flowchart is implemented by the CPU 206 executing a predetermined control program.

The flowchart in FIG. 5 illustrates a process performed upon receipt of a request from the information processing apparatus 102 to share a moving image with a third party or another service such as a social networking service (SNS). The process in the flowchart in FIG. 5 is executed in parallel with the process in the flowchart in FIG. 4.

In step S501, the information processing server 103 receives a request from the information processing apparatus 102 to share a moving image with a third party or with another service such as an SNS.

In step S502, the information processing server 103 determines whether moving image data for display being generated is set to be sharable. In a case where moving image data for display being generated is set to be sharable (YES in step S502), the processing proceeds to step S503. In a case where the moving image data for display being generated is set to be non-shareable (NO in step S502), the processing in the flowchart exits. Whether or not the moving image data for display being generated is sharable can be set uniformly in advance on the information processing server 103, or can be set by the individual user who has transmitted the request in step S501.

In step S503, the information processing server 103 determines whether moving image data for display is being generated in the process in the flowchart of FIG. 4. In a case where moving image data for display is being generated (YES in step S503), the processing proceeds to step S504. In a case where the generation of moving image data for display has been completed (NO in step S503), the processing proceeds to step S505.

In step S504, the information processing server 103 transmits and shares the moving image data for display being generated to the destination requested by the information processing apparatus 102.

In step S505, the information processing server 103 transmits the generated moving image data for display to the destination requested by the information processing apparatus 102, and shares the transmitted data.

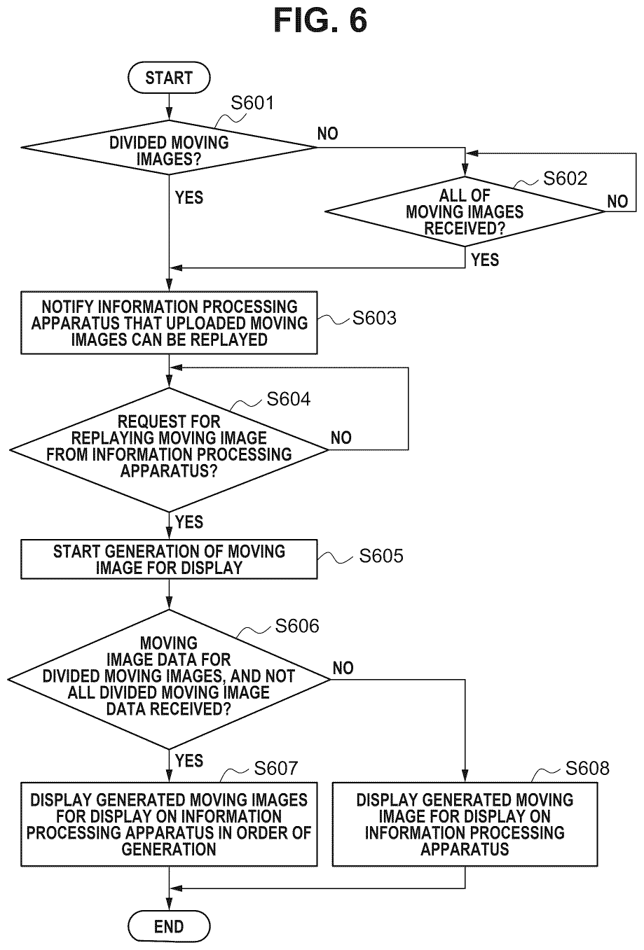

FIG. 6 is a flowchart illustrating an example of processing executed by the information processing server 103. The processing in the flowchart is implemented by the CPU 206 executing a predetermined control program.

The processing in the flowchart in FIG. 6 is processing for generating moving image data for display in response to a request for replaying a moving image from a user. Even during uploading of moving image data, when a request for replaying the moving image data is made, moving image data for display is generated from the moving image data regardless of the predetermined information.

In step S601, the information processing server 103 determines whether the moving image data transmitted from the imaging apparatus 101 is divided moving image data. In a case where the moving image data is not divided moving image data (NO in step S601), the processing proceeds to step S602. In a case where the moving image data is divided moving image data (YES in step S601), the processing proceeds to step S603.

In step S602, the information processing server 103 waits for reception of all of the moving image data (not divided moving images) transmitted from the imaging apparatus 101. Upon completion of reception of the moving image data, the processing proceeds to step S603.

In step S603, the information processing server 103 notifies the information processing apparatus 102 that the moving image data uploaded by the user can be replayed. Possible methods of notification include displaying a replay button or a pop-up on the UI screen of the information processing apparatus 102, but are not limited to specific methods.

In step S604, the information processing server 103 waits for a request for replaying moving image data from the information processing apparatus 102 in response to the notification in step S603. When the replay request has been transmitted (YES in step S604), the processing proceeds to step S605.

In step S605, the information processing server 103 generates moving image data for display of the moving image data transmitted from the imaging apparatus 101. In a case where the moving image data transmitted from the imaging apparatus 101 is divided moving image data, the information processing server 103 generates moving image data for display in the order in which they have been received.

In step S606, the information processing server 103 determines whether the condition that the moving image data transmitted from the imaging apparatus 101 is divided moving image data and not all of the divided moving image data has been received is satisfied. In a case where this condition is satisfied (YES in step S606), the processing proceeds to step S607. In a case where this condition is not satisfied (including the case where the moving image data transmitted from the imaging apparatus 101 is not divided moving image data) (NO in step S606), the processing proceeds to step S608.

In step S607, the information processing server 103 transmits the moving image data for display generated in step S605 to the information processing apparatus 102 for display in the order in which they were generated.

In step S608, the information processing server 103 transmits the moving image data for display generated in step S605 to the information processing apparatus 102 for display.

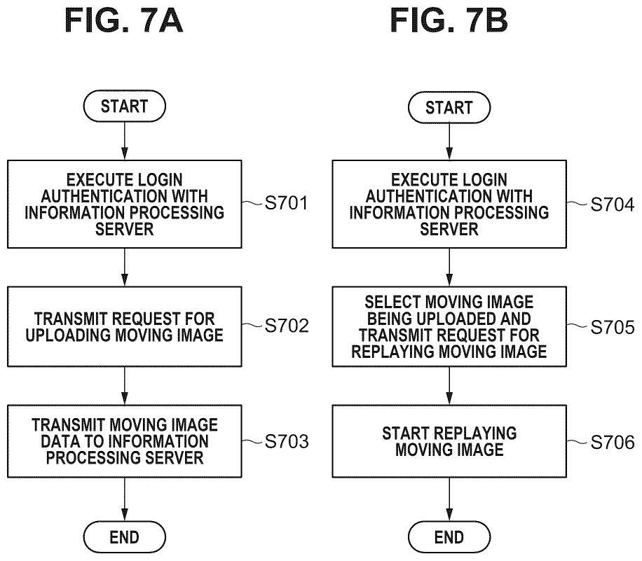

FIGS. 7A and 7B are flowcharts illustrating examples of processing executed by the imaging apparatus 101 and the information processing apparatus 102.

FIG. 7A is a flowchart illustrating an example of processing executed by the imaging apparatus 101.

In step S701, the imaging apparatus 101 executes login authentication with the information processing server 103 to implement cooperation with the service.

In step S702, the imaging apparatus 101 transmits a request for uploading the moving image data selected by the user to the information processing server 103. At this time, the imaging apparatus 101 transmits predetermined information to the information processing server. This step can be performed depending on the user's operation, but the imaging apparatus 101 can automatically transmit the predetermined information without depending on the user's operation.

In step S703, the imaging apparatus 101 transmits the moving image data selected by the user to the information processing server 103. Regardless of the user's operation, the imaging apparatus 101 can perform a division process on the moving image data and transmit the divided moving image data.

FIG. 7B is a flowchart illustrating an example of processing executed by the information processing apparatus 102.

In step S704, the information processing apparatus 102 executes login authentication with the information processing server 103 to implement cooperation with the service.

In step S705, when the moving image uploaded from the imaging apparatus 101 to the information processing server 103 is selected, the information processing apparatus 102 transmits a request for replaying the moving image to the information processing server 103. In response to this, the information processing server 103 transmits moving image data for display to the information processing apparatus 102.

In step S706, the information processing apparatus 102 sequentially replays the moving image data for display transmitted in step S705 in the order in which they have been generated. After the information processing server 103 has completed the generation of the moving image data for display, the generated moving image data for display is displayed every time a request for replaying the moving image is transmitted from the information processing apparatus 102.

As described above, at the time of uploading moving image data from the imaging apparatus 101, moving image data for display of the moving image data is generated in accordance with predetermined information. This makes it possible to generate, at the time of uploading moving image data, moving image data for display of the moving image data in effective cases, thereby achieving cost reduction.

In the exemplary embodiment, the moving image data for display is displayed on the information processing apparatus 102, but the present invention is not limited to this. For example, the moving image data for display can also be displayed on the imaging apparatus 101.

The uploading of moving image data from the imaging apparatus 101 to the information processing server 103 is not limited to a specific form, and can be performed in a form other than communication via a network. Although the moving image data is uploaded from the imaging apparatus 101 to the information processing server 103, the moving image data can also be uploaded from the imaging apparatus 101 to the information processing server 103 via the information processing apparatus 102, for example.

The information processing apparatus 102 is a data output destination from the information processing server 103 as an example, but the present disclosure is not limited to this example.

Moving image data is uploaded from the imaging apparatus 101 or the information processing apparatus 102 to the information processing server 103, and is processed by the information processing server 103, but the present disclosure is not limited to this form. Alternatively, part of the processing to be executed by the information processing server 103 can also be executed by another apparatus (e.g., the information processing apparatus 102).

The present disclosure has been described above with reference to the exemplary embodiments, however, the above exemplary embodiments merely constitute examples for carrying out the present disclosure, and the technical scope of the present disclosure should not be interpreted as being limited by these exemplary embodiments. That is, the present disclosure can be carried out in various forms without departing from its technical concept or main features.

A server apparatus to which the present disclosure is applied does not need to be constructed as a single electronic device, and can be configured such that a plurality of electronic devices operates together to fulfill its functions.

According to the present disclosure, moving image data for display of the moving image data can be generated in effective cases at the time of uploading moving image data, thereby achieving cost reduction.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™M), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-108102, filed Jul. 4, 2024, which is hereby incorporated by reference herein in its entirety.

What is claimed is:

1. A network system providing a service of uploading moving image data, comprising:
one or more memories; and
one or more processors in communication with the one or more memories, wherein the one or more processors and the one or more memories are configured to:
acquire predetermined information when accepting upload of moving image data from a moving image data transfer apparatus; and
generate moving image data for display of the moving image data at a time of uploading the moving image data from the moving image data transfer apparatus in accordance with the predetermined information.

2. The network system according to claim 1,
wherein the moving image data from the moving image data transfer apparatus is divided and uploaded, and
wherein upload of divided moving image data obtained by dividing the moving image data and generation of the moving image data for display of the divided moving image data are performed in parallel.

3. The network system according to claim 1, wherein the generated moving image data for display is transmitted for display.

4. The network system according to claim 1, wherein, in a case where there is a request for replaying the moving image data, moving image data for display of the moving image data is generated regardless of the predetermined information.

5. The network system according to claim 1, wherein the generated moving image data for display is made sharable.

6. The network system according to claim 1, wherein, in a case of uploading original moving image data and proxy moving image data of the moving image data from the moving image data transfer apparatus, the moving image data for display is generated from the proxy moving image data.

7. The network system according to claim 1, wherein the predetermined information is at least one of information on a user who uses the service and information on the moving image data.

8. A server apparatus providing a service of uploading moving image data, comprising:
one or more memories; and
one or more processors in communication with the one or more memories, wherein the one or more processors and the one or more memories are configured to:
acquire predetermined information when accepting upload of moving image data from a moving image data transfer apparatus; and
generate moving image data for display of the moving image data at a time of uploading the moving image data from the moving image data transfer apparatus in accordance with the predetermined information.

9. A control method of a server apparatus for providing a service of uploading moving image data, comprising:
acquiring predetermined information when accepting upload of moving image data from a moving image data transfer apparatus; and
generate moving image data for display of the moving image data at a time of uploading the moving image data from the moving image data transfer apparatus in accordance with the predetermined information.
